(19) United States
(12) Patent Application Publication
(10) Pub. No.: US 2015/0354243 A1
(43) Pub. Date: Dec. 10, 2015

(54) KIT FOR MOUNTING ONE OR MORE APPLIANCES ON A POLE

(71) Applicant: ACRONIMUS TECHNOLOGY, S.L., Artés (ES)

(72) Inventors: Josep TRESSERRAS PICAS, PALMA DE MALLORCA (ES); Javier VINAS GARCIA DE FALCES, TERRASSA (ES); Antonio FARGAS ANGRILL, Artés (ES)

(73) Assignee: ACRONIMUS TECHNOLOGY, S.L., ARTÉS (ES)

(21) Appl. No.: 14/762,191

(22) PCT Filed: Jan. 21, 2013
(86) PCT No.: PCT/EP2013/051056

§ 371 Date: Jul. 20, 2015

(51) Int. Cl. E04H 12/24; F21V 21/00

(52) U.S. Cl. CPC E04H 12/24; F21V 21/00

(57) ABSTRACT

A kit for mounting one or more appliances on a pole, the kit including: a central ring, a carrier base and at least one carrier arm. The central ring has a through-hole for mounting the central ring around a pole, and a fitting surface. The carrier base has a conical through-hole for fitting the carrier base on the fitting surface of the central ring and one or more side arms. And the at least one carrier arm supports one or more appliances, wherein each carrier arm is mountable by an end on one of the side arms of the carrier base.

The present disclosure relates to a kit for mounting one or more appliances on a pole, a carrier base to be used in such a kit and to a utility pole.

### BACKGROUND

Utility poles are commonly used to carry electrical power lines, including distribution lines and sub transmission lines. In urban areas, a variety of utility poles may be used for supporting telephone lines, fibre optic cables, and even traffic lights, street illumination and video cameras. It may happen that whenever a utility is installed in a neighbourhood, new poles are placed next to already existing ones. Chaotic situations may arise wherein different kinds of cables cross over and under each other and a variety of poles exist next to each other.

This kind of situation may have a number of disadvantages: firstly, maintenance work on any of the utilities involved may be complicated, and it may be difficult to install any new utility or other appliance on existing poles or new poles. Secondly, when electrical power lines are placed in the vicinity of other utility cables, electromagnetic interference may occur. Thirdly, the chaos of cables may lead to an unpleasant street view.

In order to solve the above-mentioned problems, it is known to use underground power and telephone lines instead of overhead lines. However, depending on the circumstances, an enormous investment may be necessary to replace a significant part of the overhead systems with underground systems. Such an investment may not be viable in all situations.

WO 2012025153 A1 discloses a kit for mounting one or more appliances on a pole, the kit including a central ring for being mounted around a pole and having a through-hole, a fitting surface and a support surface, and a carrier having a base part and at least one support arm extending from said base part for supporting one or more appliances, wherein said base part is adapted to be fitted on said support surface and has a through-hole adapted for being fitted around said fitting surface. This kit permits mounting several appliances on a same pole with a versatility which solves the above-mentioned problems.

The present subject matter aims at further improving the prior systems.

### SUMMARY

In a first aspect, the subject matter hereof provides a kit for mounting one or more appliances on a pole, the kit including a central ring, a carrier base and at least one carrier arm for supporting one or more appliances. The central ring has a through-hole for mounting the central ring around a pole, and a conical fitting surface. The carrier base has a conical through-hole for fitting the carrier base on the fitting surface of the central ring and one or more side arms. Each carrier arm is mountable by an end on one of the side arms of the carrier base.

In this aspect, a through-hole of a central ring may be adapted to a particular size and shape of a pole and a particular position on the pole, whereas the carrier base may be standardized to be fitted on a central ring. Moreover, the carrier base and the at least one carrier arm are separate pieces which can be assembled. Replacement of a carrier arm can be done without having to replace the carrier base, or dismounting any other part from a pole. This kit for mounting appliances on a pole is thus very versatile.

The fitting surface of the central ring and the through-hole of the carrier base may be conical which permits achieving good supporting and fitting effects between the fitting support surface of the central ring and the through-hole of the carrier base. This simple geometry may reduce the costs of manufacturing of both the central ring and the carrier base.

In some implementations, the fitting surface may include one or more protrusions and the through-hole of the carrier base may include indentations mating at least part of said protrusions. This way, the carrier base can only be fitted on top of the central ring in one or more predefined relative horizontal orientations. Hereby, assembly of a kit may be facilitated. Optionally, the indentations of the through-hole of the carrier base may be substantially identical and equispaced along an inner circumference of the through-hole.

In some implementations, the central ring may include a plurality of salient pieces at the bottom of the fitting surface for protecting cables and wires related to appliances mounted on the carrier arms.

In some implementations, the vertical orientation of at least one of the carrier arms may be adjustable. To this end, the carrier arm may include curved oblong holes for fastening the carrier arms to the side arms of the carrier base. Different inclinations of the carrier arm may be achieved by fitting the fastener at different positions along the length of the lateral elongated hole. Therefore, some implementations hereof may permit adjustable horizontal orientation (through indentations of a carrier base mating protrusions of a central ring, as explained before) and adjustable vertical orientation (through e.g. said curved oblong holes) of appliances. An aspect of this combination of adjustable horizontal and vertical orientations may make mounting of appliances more flexible and versatile, which may be very important in situations where obstacles have to be overcome to achieve specific arrangement of appliances.

In a further aspect, the developments hereof may provide a kit as substantially hereinbefore described, including at least two central rings. The first central ring has a first through-hole and a second central ring has a second through-hole of a different size than said first through-hole. The first central ring and second central ring have corresponding fitting support surfaces, such that a carrier base can be mounted on either the first central ring or on the second central ring. In this aspect, a kit is provided wherein several central rings with varying sizes of through-holes can be fitted at different heights on a utility pole (due to the taper of the pole). However, since the fitting support surface is the same in the at least two central rings, a carrier base may be fitted on any of the different heights.

In some implementations, the carrier arm may include holes for fitting electrical insulators and thus be adapted to carry electrical power lines. In some implementations, a carrier arm may include an illumination system (e.g. street lights) or may carry a traffic light.

In yet another aspect, the developments may provide a carrier base suitable for being used in a kit substantially as hereinbefore described. And in yet another aspect, the developments may provide a utility pole carrying one or more of the kits substantially as hereinbefore described.

### BRIEF DESCRIPTION OF THE DRAWINGS

Particular embodiments of the present invention will be described in the following by way of non-limiting examples, with reference to the appended drawings, in which:

FIGS. 1a-1b illustrate an implementation of a central ring in accordance with the presently-described subject matter;

FIGS. 2a-2b illustrate an implementation of a carrier base in accordance herewith;

FIGS. 3a-3b illustrate a first implementation of a carrier arm in accordance herewith;

FIGS. 4a-4b illustrate a second implementation of a carrier arm in accordance herewith;

FIGS. 5a-5b illustrate instructions for assembling a kit comprising a central ring, a carrier base and a first and second carrier arm of the types shown in preceding figures;

FIGS. 6a-6b partially illustrate the kit shown in FIGS. 5a-5b once assembled;

FIG. 7 illustrates a utility pole according to an implementation hereof;

FIGS. 8a-8b illustrate a kit similar to the one shown in FIGS. 5a-5b but assembled and further comprising a holding piece, according hereto;

FIGS. 9a-9d illustrate different arrangements of a same carrier base with one or more supporting plates mounted on said carrier base, according hereto; and

FIGS. 10a-10b illustrate another implementation of a central ring in accordance herewith.

### DETAILED DESCRIPTION

In the following description, numerous specific details are set forth in order to provide a thorough understanding of the present inventions. It will be understood by one skilled in the art however, that the present inventions may be practiced without some or all of these specific details. In other instances, well known elements have not been described in detail in order not to unnecessarily obscure the description of the present inventions.

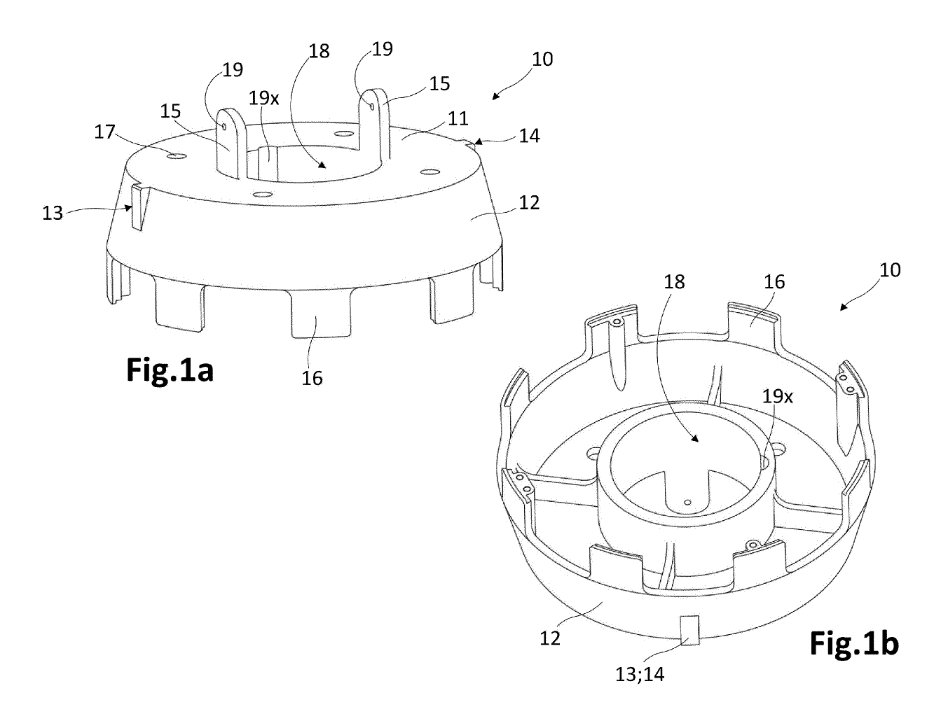

FIGS. 1a-1b illustrate a first implementation of a central ring according to the presently-described subject matter. FIG. 1a gives a perspective view of the central ring 10 and FIG. 1b gives a perspective view of the same central ring 10 but turned upside down with respect to the position shown in FIG. 1a.

With reference to FIGS. 1a-1b, a central ring 10 is shown having a fitting surface 12 with a conical tapered shape. This fitting surface 12 may be seen as an outer surface of the central ring 10. This central ring 10 further has a through-hole with an internal sidewall 18, which would correspond to an inner surface of the central ring 10. In this implementation, the fitting support surface 12 has a first protrusion 13 and a second protrusion 14, which are located on opposite sides of the outer surface of the central ring 10. Alternatively to these two protrusions 13, 14, the fitting support surface 12 may have another number of protrusions. They may be substantially equispaced along a circumferential length of the tapered fitting support surface 12.

In this implementation, the central ring 10 has holes 17 in a top surface 11 of the central ring 10 for fixing a carrier base (or similar) on it, and two salient top pieces 15 with corresponding holes 19 for fixing the central ring 10 to a pole. This central ring 10 may also include bottom salient pieces 16 by way of flaps suitable for protecting cables or similar elements related to appliances. The functionalities of various characteristics of the central ring 10 according to this implementation will be further explained later on.

The central ring 10 may further have one or more troughs (not shown) on a top surface 11. These troughs may serve for positioning and guiding cables and wires leading to and from various utilities and/or other appliances to be mounted on a pole.

The through-hole of the central ring 10 may be tapered and may have a substantially circular cross-section. Within the scope hereof, any other cross-sectional shape may be used. An aspect of a tapered cross-section is that it may form an interlocking fit on a tapered pole. No additional fasteners would be necessary to ensure a stable connection. However, in some implementations hereof, additional fasteners such as screws or bolts may be provided to fix the central ring 10 in position with respect to the pole. To this end, fastener holes 19 may be provided, as commented before. These fastener holes may be provided in implementations with through-holes with a tapered cross-section or with a straight cross-section.

Also, in some implementations hereof, the through-hole of the central ring 10 may have an indentation 19x to adapt for a weld bead which may be present at the external surface of a pole.

The central ring may include troughs, which may serve to guide cables or wiring to an interior of a pole. To this end, the pole should be provided with holes in appropriate locations, either during manufacture of the pole or e.g. by drilling after installation of a kit on the pole. The cables or wiring may e.g. be connected to an electrical appliance mounted on a pole, such as e.g. a security camera.

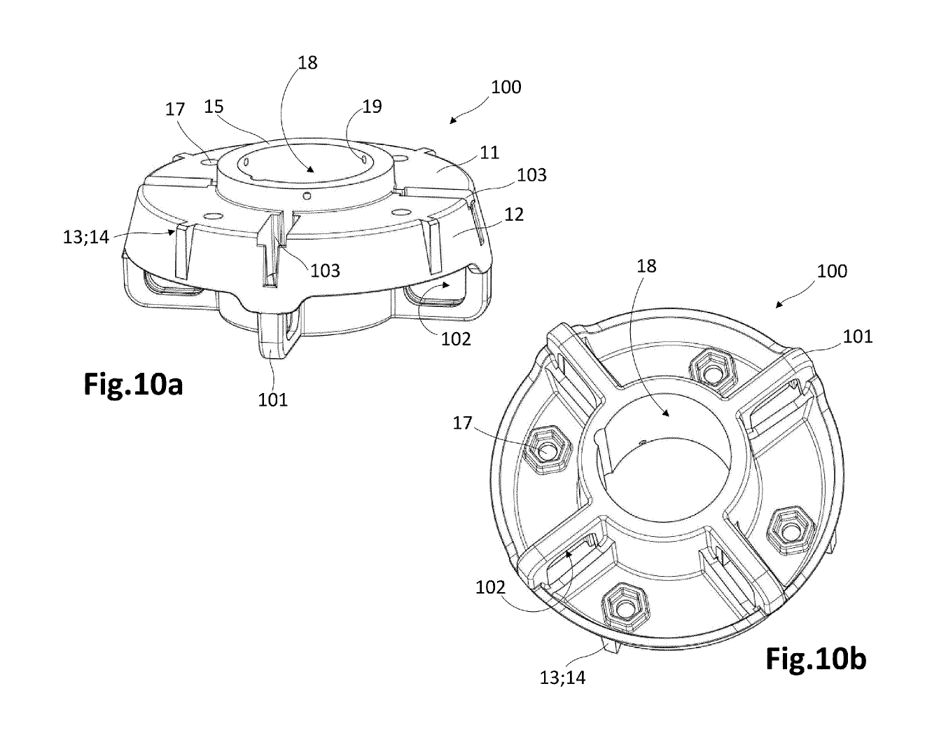

FIGS. 10a-10b illustrate a second implementation of a central ring according hereto. FIG. 10a gives a perspective view of the central ring 100 and FIG. 10b gives a perspective view of the same central ring 100 but turned upside down with respect to the position shown in FIG. 10a.

This central ring 100 is similar to the one shown in FIGS. 1a-1b. A difference is that the central ring 100 has several radial O-shaped pieces 101 having or defining respective holes 102 through which cables (or similar elements) related to e.g. appliances may be passed and, therefore, suitably hold. This central ring 100 is shown having four of said O-shaped pieces 101, but other numbers of such pieces 101 may be taken into account to achieve the goal of suitably holding cables or similar. Another difference is that each of said O-shaped pieces 101 has a related sunken region 103 on the fitting support surface 12 and top surface 11. These sunken regions 103 may make the extraction of the central ring 100 from a mould easier. Apart from moulding, other known techniques may be used to construct this central ring 100 (with or without said sunken regions 103). A further difference is that this central ring 100 does not have the bottom salient pieces 16 of FIGS. 1a-1b. A still further difference is that this central ring has a unique salient top piece 15 with tubular shape.

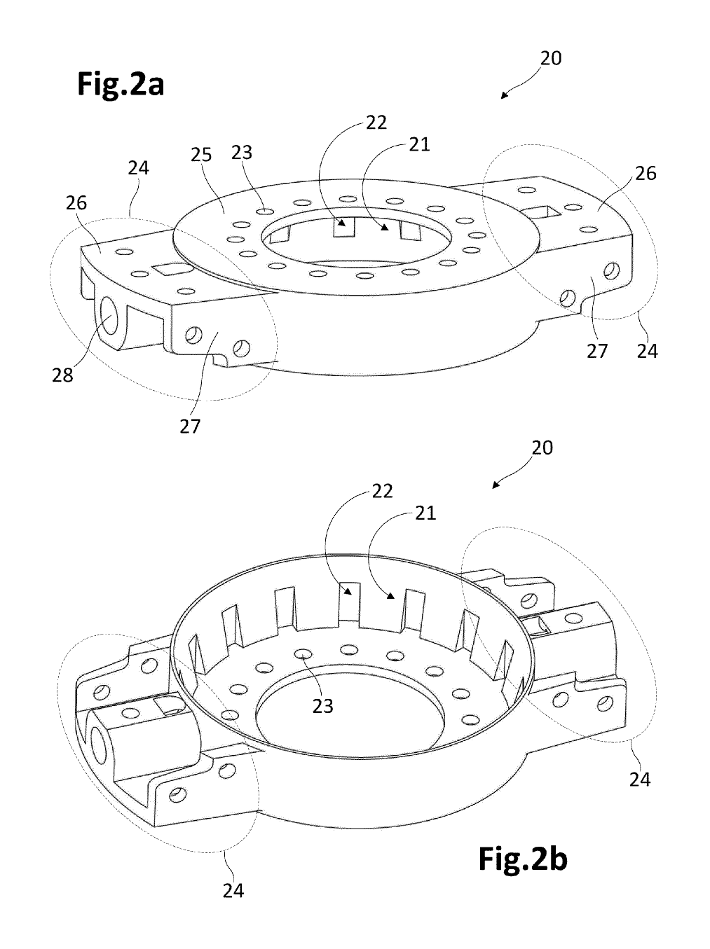

FIGS. 2a-2b illustrate an implementation of a carrier base in accordance herewith. FIG. 2a gives a perspective view of the carrier base 20 and FIG. 2b gives a perspective view of the same carrier base 20 but turned upside down with respect to the position shown in FIG. 2a.

FIGS. 2a-2b show a carrier base 20 having a through-hole with an internal sidewall 21 with a tapered shape, for fitting the carrier base 20 to the fitting surface 12 of a central ring 10 as the one shown in FIGS. 1a-1b and 10a-10b. The internal surface 21 of the carrier base's through-hole has mating indentations, such that the carrier base can be fitted in a limited number of horizontal orientations with respect to a central ring of the type shown in FIGS. 1a-1b and 10a-10b. This aspect may be useful especially when a plurality of central rings, carrier bases and carrier arms is mounted on the same pole. In order to reduce electromagnetic interference, it may be useful to use different horizontal orientations for different electrical power lines. Additionally, when different utility cables (electrical, phone, optical fibre) are mounted on the same pole, but are to be transported in different directions, the different horizontal orientations of the carrier bases and carrier arms may come in handy. It will be clear that many different sizes and shapes of protrusions and indentations may be provided to fulfil the described function.

The carrier base 20 also has a plurality of holes 23 on a top surface 25 for fitting a fastener to fix the carrier base 20 on a central ring 10 as the ones described hereinbefore. FIGS. 2a-2b further shows two side arms 24 of the carrier base 20, each of said side arms 24 having suitable configurations to support a carrier arm for supporting one or more appliances. Each of the side arms may have a top surface 26 and two side surfaces 27 perpendicular to the top surface 26. The top surfaces 26 and side surfaces 27 may have corresponding fitting shapes and holes for fitting fasteners (e.g. screws) to fix the carrier arm to the carrier base 20. The side arms 24 may have a cylindrical hole 28 for fitting a tubular portion of an appliance, such as e.g. a flagpole, cables, etc.

In some implementations, the carrier base 20 may have more than two (three, four or more) side arms 24, such that the carrier base 20 may carry more than two (three, four or more) carrier arms.

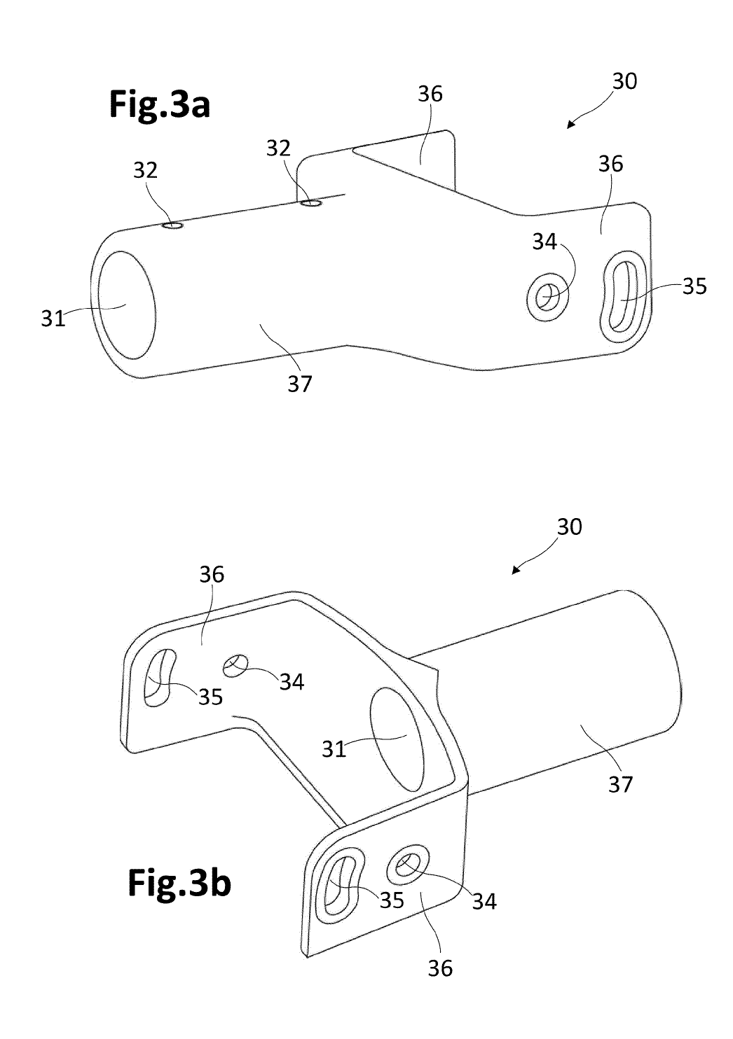

FIGS. 3a-3b illustrate a first implementation of a carrier arm in accordance herewith. FIG. 3a gives a perspective view of this carrier arm 30 and FIG. 3b gives a perspective view of the same carrier arm 30 but from the back.

This carrier arm 30 has a tubular part 37 with a longitudinal through-hole 31. The through-hole 31 may receive a fitting region of an appliance such that the appliance may be reliably supported by the carrier arm 30. The tubular part 37 may further have corresponding holes 32 for fitting fasteners (e.g. screws or bolts) to fix the received part of the appliance to the carrier arm 30. This carrier arm 30 may also include a structure with two lateral regions 36 with corresponding holes 34, 35 for fitting fasteners to fix the carrier arm 30 to the side arms of a carrier base 20 as the one shown in FIGS. 2a-2b. Both holes 34, 35 may have the common function of fixing the carrier arm 30 to the carrier base 20. The curved oblong hole 35 additionally permits a variable inclination of the carrier arm 30. This variable inclination will depend on the position along the length of the elongated and curved hole 35 where the corresponding fastener (e.g. screw or bolt) is fitted and tightened.

Therefore, in some implementations, appliances may be mounted on a pole with adjustable horizontal and vertical orientations. The adjustable horizontal orientation may be achieved in the way commented with respect to FIGS. 2a-2b (indentations of a carrier base mating different protrusions of a central ring). The adjustable vertical orientation may be implemented in the way commented with respect to FIGS. 3a-3b (carrier arm with e.g. curved oblong holes). An advantage of this adjustable horizontal and vertical orientation may be that mounting of appliances is more flexible and versatile, which may be very important in situations where obstacles have to be overcome to achieve particular arrangement of appliances.

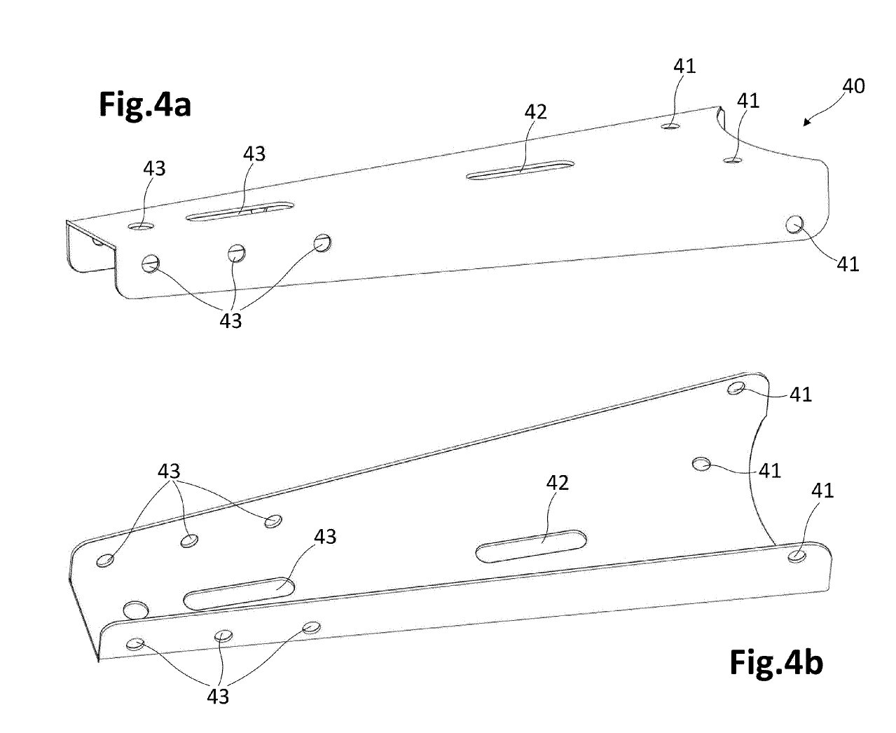

FIGS. 4a-4b illustrate a second implementation of a carrier arm in accordance herewith. FIG. 4a gives a perspective view of this carrier arm 40 and FIG. 4b gives a perspective view of the same carrier arm 40 but turned upside down with respect to the position of FIG. 4a.

In this implementation, the carrier arm 40 has a first end with suitable shape to be fitted in/on a side arm 24 as the ones shown in FIGS. 2a-2b, and a second end with suitable shape to mount a pertinent appliance in/on it. Once the carrier arm 40 has been mounted on a carrier base 20, the first end would correspond to the proximal end with respect to the carrier base 20, and the second end would correspond to the distal end with respect to the carrier base 20. The first end (proximal end) of the carrier arm 40 may have suitable holes 41 to fit fasteners for fixing the carrier arm 40 to the carrier base 20. The side arm 24 may have a large plurality of holes, such that some of said holes could be selected depending on the carrier arm to be fixed. The second end (distal end) of the carrier arm 40 may have suitable holes 43 to fit fasteners for fixing an appliance to the carrier arm 40. This carrier arm 40 may also have intermediate holes 42 between the first and second ends. Some of the “distal” and intermediate holes 43, 42 may be adapted to fit electrical insulators, so that electrical power lines may be mounted on top of the carrier arm. This carrier arm 40 has a cross-section with 11 shape, the size of H progressively decreasing from the proximal end towards the distal end. Alternatively, the carrier arm 40 may have other suitable cross-sections, such as e.g. circular, square, triangular, hexagonal etc.

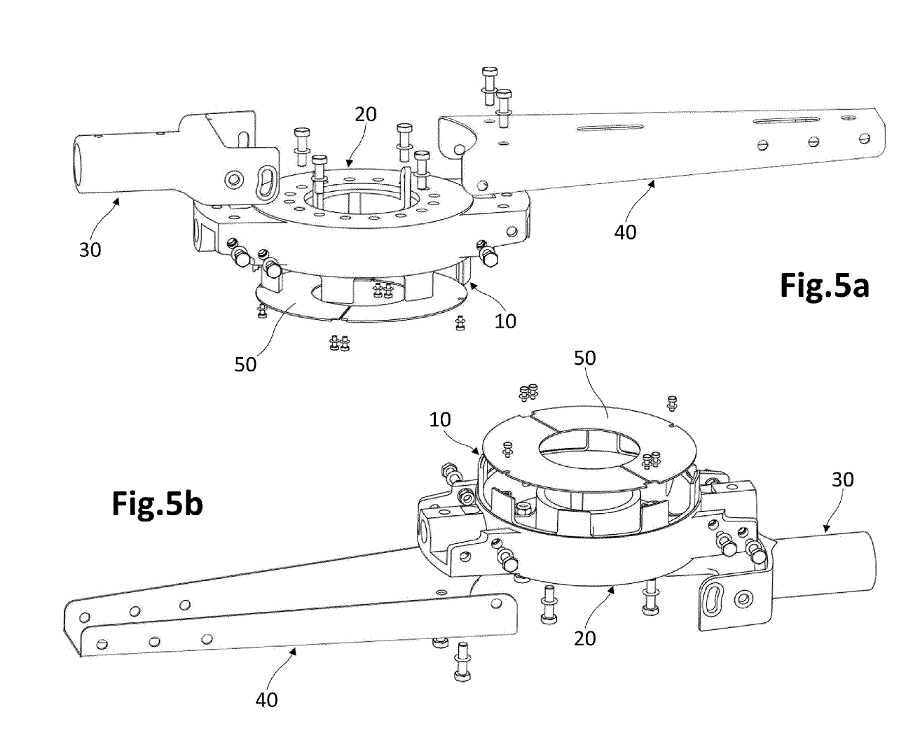

FIGS. 5a-5b illustrate exploded views of an assembly of a kit including a central ring 10, a carrier base 20 and two different carrier arms 30, 40 of the types shown in preceding figures. FIGS. 5a-5b additionally show a bottom plate 50 which has the function of protecting cables or other similar elements housed in the central ring. These cables or similar elements may e.g. be associated with appliances to be mounted.

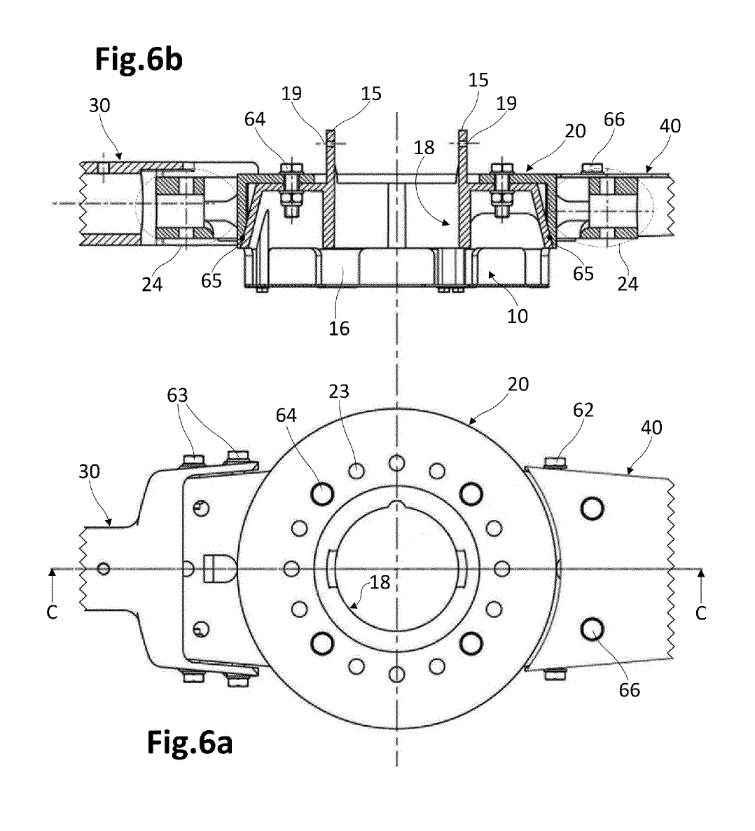

FIGS. 6a-6b partially illustrate the kit shown in FIGS. 5a-5b once assembled. FIG. 6a gives a partial top view of the assembled kit, and FIG. 6b gives a cross-sectional view along the line C-C (illustrated in FIG. 6a). FIG. 6a shows the carrier base 20 mounted on the central ring 10 with several bolts 64 fitted in corresponding holes 23 and fixed with nuts for fixing the carrier base 20 to the central ring 10. FIG. 6a also shows part of the first carrier arm 30 mounted on the carrier base 20 with various bolts 63 fitted in corresponding holes and fixed with nuts for fixing the carrier arm 30 to the carrier base 20. FIG. 6a also shows part of the second carrier arm 40 mounted on the carrier base 20 with various bolts 62, 66 fitted in corresponding holes and fixed with nuts for fixing the carrier arm 40 to the carrier base 20.

FIG. 6b shows how the central ring 10 fits into the carrier base 20 and how some bolts 64 (and corresponding nuts) fix the carrier base 20 to the central ring 10. An aspect is how the tapered internal sidewall 21 of the through-hole of the carrier base 20 (see FIGS. 2a-2b) fits on the tapered fitting support surface 12 of the central ring (see FIGS. 1a-1b and 10a-10b). The interface of the tapered or conical surfaces is indicated in FIG. 6b by the reference number 65. This tapered interface has been shaped such that the central ring reliably supports the carrier base 20 and corresponding carrier arms 30, 40, with the advantage that this tapered shape may be cheaper to manufacture in comparison with other options. FIG. 6b also shows a plurality of salient pieces 16 at the bottom for protecting cables and wires related to appliances, said bottom salient pieces 16 being part of the central ring 10.

FIG. 6b further shows the through-hole with internal sidewall 18 of the central ring 10 for mounting the central ring 10 around a pole, and top salient pieces 15 with corresponding holes 19 for fixing the central ring 10 to the pole. FIG. 6b also illustrates how the first carrier arm 30 is fitted in/on a first side arm 24 of the carrier base 20, and how the second carrier arm 40 is fitted in/on a second side arm 24 of the carrier base 20.

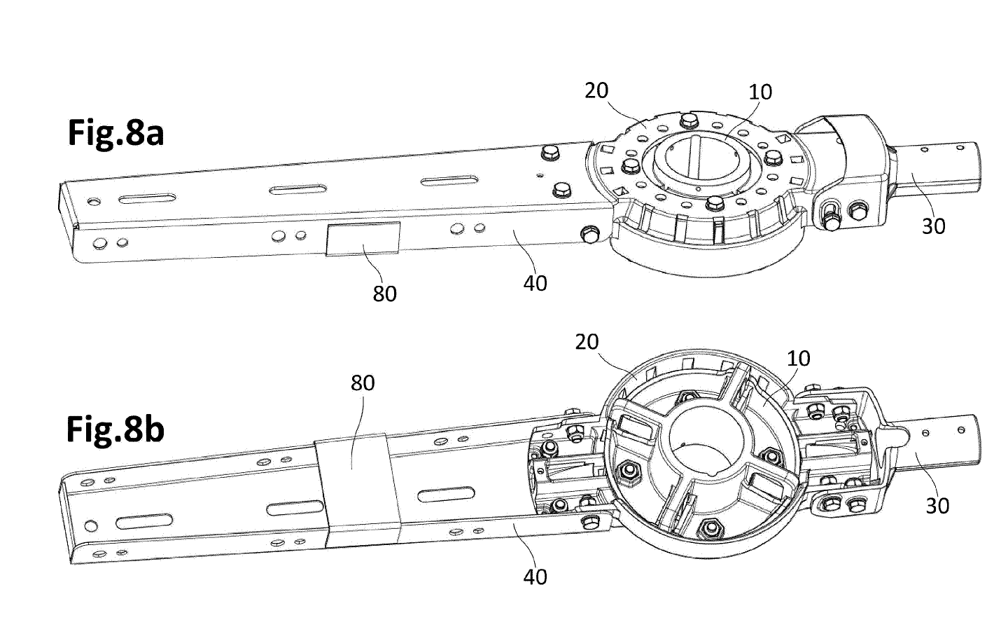

FIGS. 8a-8b illustrate a kit similar to the one shown in FIGS. 5a-5b but assembled and further including a holding piece, according hereto. FIG. 8a shows a perspective view of the kit disposed in a normal position of use, while FIG. 8b gives a perspective view of the same kit but turned upside down with respect to the position of FIG. 8a. In both figures, a corresponding central ring 10, carrier base 20 and carrier arms 30, 40 are shown assembled. The carrier arm 30 is very similar to the one illustrated in FIGS. 3a and 3b, whereas the carrier arm 40 is very similar to the one illustrated in FIGS. 4a and 4b.

Still with reference to FIGS. 8a and 8b, a holding piece 80 with substantially U-shaped cross-section is shown coupled with the carrier arm 40. This coupling may be achieved e.g. by using a proper adhesive or by attributing to the holding piece 80 a suitable size to cause enough pressure between respective surfaces of the carrier arm 40 and the holding piece 80 when coupled (i.e. to “snap” or “clip” onto the carrier arm). Alternative fasteners may also be used, such as e.g. screws or similar. Of course, further holding pieces 80 could be arranged (in a similar way) along the carrier arm 40 to improve holding of e.g. cables passing through the cavity of the carrier arm 40 aimed at that end. One or more of said holding pieces 80 arranged along a carrier arm 40 may make the carrier arm 40 to have an increased stiffness.

The central ring 10 of FIGS. 8a and 8b is similar to the central rings shown in FIGS. 1a-1b and 10a-10b. This central ring 10 is shown without the bottom salient pieces 16 of the central ring of FIGS. 1a-1b and 5a-5b, and without the bottom plate 50 of FIGS. 5a-5b. This central ring 10 is shown having the bottom ring shaped pieces 101 of the central ring of FIGS. 10a-10b.

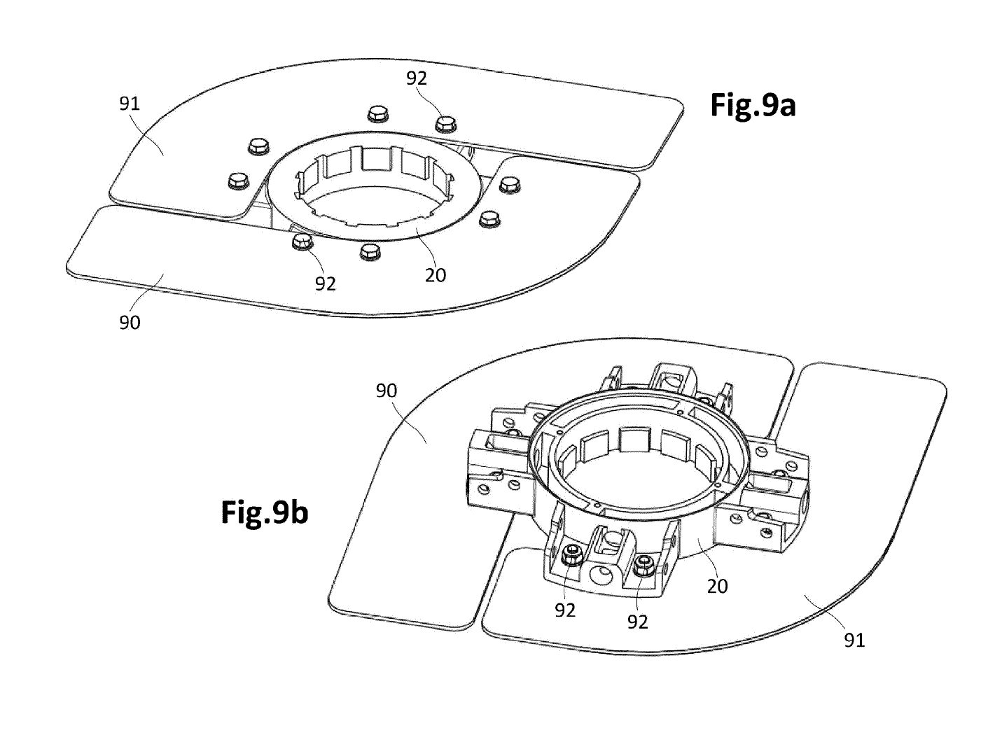

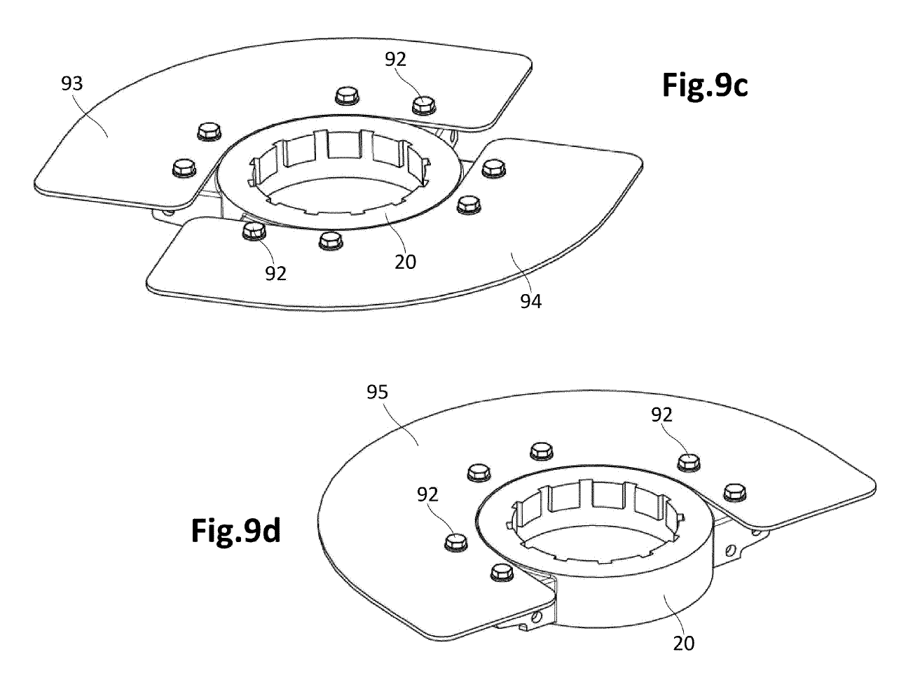

FIGS. 9a-9d illustrate different arrangements of a same carrier base with one or more different supporting plates mounted on said carrier base, according to alternatives hereof. FIG. 9a shows a perspective view of one of said arrangements, in which two L-shaped supporting plates 90, 91 are mounted on the carrier base 20 and fixed through corresponding screws 92. FIG. 9a shows a perspective view of the carrier base 20 with L-shaped supporting plates 90, 91 disposed in a normal position of use. FIG. 9b gives a perspective view of the same arrangement but turned upside down with respect to the position of FIG. 9a. FIG. 9c illustrates an arrangement very similar to the one shown in FIGS. 9a-9b but comprising two C-shaped supporting plates 93, 94, i.e. with a shape different from the shape of the supporting plates 90, 91 of FIGS. 9a and 9b.

FIG. 9d shows another arrangement of the same type, but, in this case, just having one semicircle-shaped supporting plate 95, i.e. with a shape different from the shape of the supporting plates 90, 91, 93, 94 of FIGS. 9a, 9b and 9c. All the arrangements illustrated by FIGS. 9a-9d are suitable for supporting particular devices, such as e.g. transformers, accumulators, solar panels, etc. which may be useful for certain appliances mounted on a same pole. For example, one or more solar panels could be mounted on supporting plates of the described type to supply power to a traffic light mounted on the same pole.

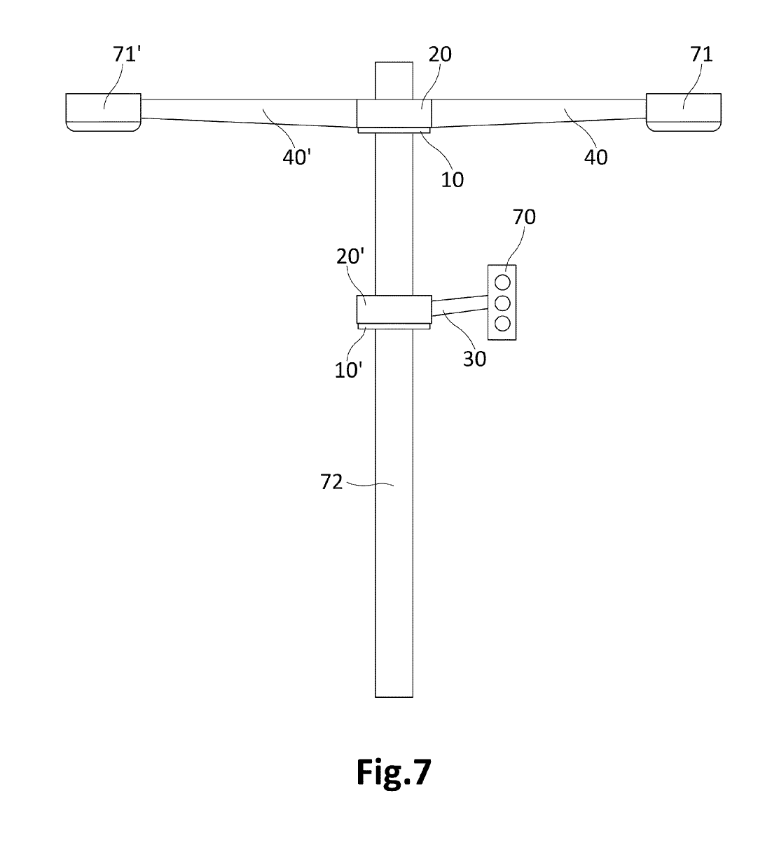

FIG. 7 illustrates a utility pole having alternative assembled kits according to alternatives hereof. In these kits, the carrier bases 20 and 20′ are mounted on central rings 10 and 10′ respectively. The carrier base 20 supports two carrier arms 40 and 40′ of the type shown in FIGS. 4a-4b. The carrier base 20′ supports a carrier arm 30 of the type shown in FIGS. 3a-3b. The shown carrier arms 30, 40, 40′ may have different lengths depending on the particular circumstances. In certain implementation hereof, the carrier bases need merely be placed on the central rings in order to fix them in their relative position. The through-hole of a carrier base may be adapted to be fitted around the central ring's fitting support surface. In alternative implementations, it may be necessary or preferable to provide further fasteners to fix a carrier base with respect to a central ring.

One or more lateral holes may be provided in top salient parts of a central ring to house e.g. bolts to fix the central ring with respect to the pole 72. The bolts may penetrate to the interior of the pole 72, or may simply exert a sufficient pressure on the external surface of the pole. Furthermore, substantially vertical holes may be provided in a top surface of the central ring in order to fix the carrier base with respect to the central ring using suitable bolts.

The pole 72 may have a tapering circular cross-section. The heights at which the central rings 10 and 10′ are mounted may be determined by the size of the through-holes of the central rings. The central rings may be slid down the pole until the internal surface of the through-hole interlocks with the pole's external surface. In this case, the pole and through-holes of the central rings are of circular cross-section. The central ring with the through-hole of greatest diameter may be mounted first by sliding down the pole, followed by the central ring with a through-hole of second greatest diameter etc.

Although the central rings 10 and 10′ have different through-holes, their fitting support surfaces may be the same to a large extent. In this aspect, carrier base 20 may be mounted on central ring 10, but it could also be mounted on central ring 10′. Also the other carrier base could be mounted on any of the central rings. A modular concept for a utility pole is thus provided which may be quickly and easily installed, and can also easily be adapted to different needs. A further aspect of the modular concept is that the different parts may be easily manufactured at low cost. In alternatives hereof, the carrier bases do not need any fasteners to fix them with respect to the central rings (due to the interlocking fit between them), and the central rings may not need any fasteners to be fixed with respect to the pole (because of the interlocking fit of the internal surface of the tapered through-hole with the conical pole). These implementations may thus be particularly easy to assemble.

The carrier bases 20, 20′ (and associated carrier arms 30, 40, 40′) may have substantially the same or different orientations with respect to the central rings. As previously explained, the relative orientations of the carriers may be varied in accordance with circumstances.

In certain implementations, electromagnetic interference between different utilities may be a problem. This problem may be reduced by increasing the distance between the utilities and/or changing their relative orientations. One or both of these adjustments may be done relatively easily in various implementations hereof.

It may be seen in FIG. 7, that different utilities may be mounted on the pole. The carrier base 20′ and carrier arm 30 has (or may be adapted to carry) a traffic light 70, whereas the carrier base 20 and carrier arms 40, 40′ may be adapted to carry lamps 71, 71′ for street illumination (as shown in the figure), but other types of appliances are possible, such as e.g. electrical power lines, telephone lines or other. The lamps 71, 71′ may be supplied with electricity through the use of batteries or through cables running down in the pole.

The pole 72 may have tapering cross-section which may be circular, triangular, square (or rectangular) and hexagonal. It will be clear however, that further alternative cross-sections are also possible, e.g. pentagonal, heptagonal etc.

An alternative and/or additional aspect hereof is that only the through-hole of the central ring needs to be adapted to the pole upon which it is to be mounted. This through-hole may thus also be of circular, triangular, etc. cross section. The carrier bases are merely adapted to be fitted to the fitting support surface(s) of the central ring(s). The height of the utility pole may be varied freely, but for most of the implementations mentioned, heights between 6 meters and 12 meters may be most advantageous.

Although poles of tapering cross-section have advantages (e.g. an interlocking connection may be achieved with a tapered through-hole of a central ring), the developments hereof may also be used with poles of cylindrical (i.e. non-tapering) cross-section. In these arrangements, usually at least one additional fastener would be needed to fix a central ring with respect to a pole. When a plurality of kits is to be mounted on a cylindrical pole, the central rings and their through-holes may all be of the same size. In accordance with circumstances, carrier bases may then be selected to fit on any of the central rings.

Furthermore, only a limited number of all possible appliances that may be mounted on a pole have been illustrated. Non-illustrated alternative appliances include (but are not limited to): transformers, optical fibre, telephone, ADSL, Internet connection, photovoltaic systems, Wi-Fi, low voltage and medium voltage electrical power lines, webcams, security cameras, speed cameras, traffic cameras, street lighting and non-public lamps.

Although only a number of particular embodiments and examples of the inventions hereof have been disclosed herein, it will be understood by those skilled in the art that other alternative embodiments and/or uses of the inventions and obvious modifications and equivalents thereof are possible. Furthermore, the present inventions cover all possible combinations of the particular embodiments described. Thus, the scope of the present inventions should not be limited by particular embodiments, but should be determined only by a fair reading of the claims that follow.

1. A kit for mounting one or more appliances on a pole, the kit comprising:
a central ring having a through-hole for mounting the central ring around a pole, and a conical fitting surface,
a carrier base having a conical through-hole for fitting the carrier base on the fitting surface of the central ring and one or more side arms, and
at least one carrier arm for supporting one or more appliances, each carrier arm being mountable by an end on one of the side arms of the carrier base.

2. A kit according to claim 1, wherein the fitting surface comprises one or more protrusions and the through-hole of the carrier base comprises indentations mating at least part of said protrusions.

3. A kit according to claim 2, wherein the indentations of the through-hole of the carrier base are substantially identical and equispaced along the inner circumference of the through-hole.

4. A kit according to claim 1, wherein the central ring comprises a plurality of salient pieces at the bottom of the fitting surface for protecting cables and wires related to appliances.

5. A kit according to claim 1, wherein the through-hole of the central ring is adapted to form an interlocking connection with a pole.

6. A kit according to claim 5, wherein the through-hole is tapered.

7. A kit according to claim 1, wherein the carrier base is adapted to carry two carrier arms mountable by an end on the carrier base.

8. A kit according to claim 1, wherein the orientation of at least one of the carrier arms is adjustable.

9. A kit according to claim 8, wherein the carrier arms comprise two curved oblong holes for fastening the carrier arms to the side arms of the carrier base.

10. A kit according to claim 1, wherein at least one of the side arms of the carrier base comprises a top surface and two side surfaces that are perpendicular to the top surface.

11. A kit according to claim 1, wherein at least one of the side arms comprises a cylindrical hole.

12. A kit according to claim 1, wherein the central ring comprises at least two salient top pieces with a hole for fitting a fastener to fasten the central ring to the pole.

13. A kit according to claim 1, wherein the central ring further comprises a top surface with one or more fastening holes and the carrier base comprises a bottom surface with one or more corresponding fastening holes for fixing the carrier base to the central ring.

14. A kit according to claim 1, comprising at least two central rings, wherein
a first central ring has a first through-hole and a second central ring has a second through-hole of a different size than said first through-hole, and wherein
said first central ring and second central ring have corresponding fitting surfaces, such that a carrier base can be mounted on either the first central ring or on the second central ring.

15. A kit according to claim 1, wherein one or more of the carrier arms comprises holes near its end for fitting electrical insulators.

16. A kit according to claim 1, wherein one or more of the carrier arms comprises or is adapted to carry an illumination system.

17. A kit according to claim 1, wherein one or more of the carrier arms comprises or is adapted to carry a traffic light.

18. A kit according to claim 1, further comprising at least one pole around which a central ring of the kit may be mounted.

19. A carrier base suitable for being used in a kit according to claim 1.

20. A utility pole carrying one or more of the kits according to claim 1.
